(19) United States
(12) Patent Application Publication
(10) Pub. No.: US 2010/0053046 A1
(43) Pub. Date: Mar. 4, 2010

(54) BACKLIGHT DEVICE AND IMAGE DISPLAY APPARATUS USING THE SAME

(75) Inventor: Hideyuki NAKANISHI, Okayama (JP)

Correspondence Address: HAMRE, SCHUMANN, MUELLER & LARSON P.C., P.O. BOX 2902-0902, MINNEAPOLIS, MN, 55402, US

(73) Assignee: Panasonic Corporation, Kadoma-shi, Osaka (JP)

(21) Appl. No.: 12/546,332

(22) Filed: Aug. 24, 2009

(30) Foreign Application Priority Data
Aug. 27, 2008 (JP) 2008-218554

(51) Int. Cl. G09G 3/36; G09G 3/32

(52) U.S. Cl. 345/82; 345/102

(57) ABSTRACT

In a backlight device that performs an area control, part of a plurality of light emitting sections is configured based on a relationship where, between at least two light emitting sections controlled by a first control unit, at least one light emitting section controlled by a second control unit that is different from the first control unit, is provided.

### CROSS REFERENCE TO RELATED APPLICATIONS

The disclosure of Japanese Patent Application No. 2008-218554, filed on Aug. 27, 2008, including the specification, drawings and abstract, is incorporated herein by reference in its entirety.

### TECHNICAL FIELD

The technical field relates to a backlight device and an image display apparatus using the same.

### BACKGROUND ART

Display apparatuses are classified into two categories: light emitting display apparatuses that do not require light sources such as CRT (Cathode Ray Tube) and plasma display apparatus; and non-light emitting display apparatuses that require light sources such as liquid crystal displays (also referred to as “liquid crystal display apparatuses”) and electrochromic display apparatuses.

There are non-light emitting display apparatuses that use reflective optical modulating elements which adjust the amount of reflected light according to image signals, and there are non-light emitting display apparatuses that use transmissive optical modulating elements which adjust the amount of transmission light according to image signals. Further, there are liquid crystal display apparatuses that use liquid crystal display elements (also referred to as “liquid crystal panels”) as transmissive optical modulating elements and that have lighting devices (also referred to as “backlight devices” or simply “backlight”) in the back of the liquid crystal display elements, and these liquid crystal display apparatuses are thin and light and, consequently, are employed for various display apparatuses such as monitors of computers, televisions and mobile telephones.

Recently, backlight devices (hereinafter also referred to as “LED backlight apparatuses” or simply “LED backlights”) that use LEDs (Light Emitting Diodes) are gaining popularity as backlight devices for non-light emitting display apparatuses (for example, liquid crystal displays) that require light sources. That is, LED backlight devices are gaining popularity as a technology to save power and make thinner devices.

An LED backlight adopts an area control technology, whereby a plurality of LEDs are arranged in the back of a liquid crystal panel and are controlled individually, so that only the required areas emit a required amount of light according to a display image by, for example, arranging a plurality of LEDs in the back of the liquid crystal panel and controlling each LED individually, and has characteristics of saving power and expanding the dynamic range (see Patent Literature 1 and Patent Literature 2).

FIG. 1 is a view showing a schematic configuration of a conventional LED backlight device, and shows LED arrangements and a configuration example of LED drivers in case where a light source is provided right below the liquid crystal panel to perform control on a per area basis.

Backlight device 1 in FIG. 1 has LEDs 3 and LED drivers 5 that drive LEDs 3. In the example of FIG. 1, one LED driver 5 is connected to sixteen (16) LEDs 3. These sixteen (16) LEDs 3 constitute separate sub-light source 7. Backlight device 1 employs a configuration where the entire light source is divided into 15 (=5×3) sub-light sources 7 by arranging five (5) columns of sub-light sources 7 horizontally and arranging three (3) rows of sub-light sources 7 vertically. Further, backlight device 1 controls each one of fifteen (15) LED drivers 5, thereby controlling luminance of the light source on a per area basis.

### Citation List

### Patent Literature

PTL1: Japanese Patent Application Laid-Open No. HEI3-198026

### PTL2: Japanese Patent Application Laid-Open No. 2001-142409

### PTL3: Japanese Patent Application Laid-Open No. 2005-258403

### SUMMARY

### Technical Problem

However, with such a conventional configuration, that is, with a configuration where the light source is divided into a plurality of areas and luminance of the light source is controlled on a per area basis, it is difficult to make the number of divisions of the light source (i.e. the resolution of the light source) the same as the resolution of the panel. Accordingly, with the conventional configuration, the resolution of the light source is generally lower than the resolution of the panel. Therefore, negative effects are produced from the differences between the resolution of the light source and the resolution of the panel.

FIG. 2 illustrates how an image looks when a conventional LED backlight device performs an area control of the light source. Here, FIG. 2A shows how a display image moves, FIG. 2B shows how the area illuminated by the backlight device moves and FIG. 2C shows how an actual image looks when the display image and the area illuminated by the backlight device overlap.

To be more specific, (A1) to (A3) in FIG. 2A show display images that are displayed on the liquid crystal panel, and show that object 9 moves sequentially from (A1) to (A2) and then (A2) to (A3), in order over time. The arrows in (A1) to (A3) show the directions in which object 9 moves. Further, (B1) to (B3) in FIG. 2B correspond to (A1) to (A3) in FIG. 2A, respectively, and show the lighting operation of the backlight in each period of (A1) to (A3). With the example of FIG. 2, the light source in the backlight is divided into areas of five (5) columns and three (3) rows and is configured to control luminance of each area 11 separately. With a conventional area control, as shown in FIG. 2A and FIG. 2B, luminance of the light source is controlled to follow an image according to the motion of white object 9. That is, the area illuminated by the backlight is moved sequentially from (B1) to (B2) and then (B2) to (B3), in order, according to the motion of object 9. At this point, the resolution of the light source is low, and, therefore, as shown in FIG. 2C, when object 9 crosses the boundary of the light source, the size of area 15 emitting bright light changes significantly (see (C2) in particular), and, consequently, the relationship between the image and the light source is not maintained and the display becomes unnatural. That is, conventional area control has a problem that, when an object, which, ideally, needs to be displayed with uniform luminance, moves across divided areas of the light source and significant differences in luminance are produced due to the motion of the object and the image of the object looks unusual, that is, image quality deteriorates.

Here, to solve such a problem, for example, Patent Literature 3 discloses a method of showing a portion where luminance of the light source and an image that is actually displayed are different, with the correct luminance by correcting an image signal. This method is anticipated to be advantageous to some degree to improve the mismatch between luminance of the light source and the image, caused by the low resolution of the light source compared to the image. However, according to this method, the black pixels shown in FIG. 2 cannot be corrected by correcting image signals, and, therefore, it is also true that the advantage thereof is very limited.

The object is to provide a backlight device that divides the light source into a plurality of areas and controls luminance of the light source on a per area basis, and that does not produce significant differences in luminance and that can prevent deterioration of image quality, even when the object which, ideally, needs to be displayed with uniform luminance, moves across divided areas of the light source.

### Solution to Problem

To achieve the above object, the backlight device that illuminates an optical modulating section, which displays an image according to an image signal, with illuminating light to allow the optical modulating section to display the image, employs a configuration which includes: a plurality of light emitting sections that emit the illuminating light to illuminate the optical modulating section, at least one of which is arranged with respect to each of a plurality of divided areas to illuminate the illuminating light separately in a plurality of areas; and a controlling section that, using the at least one of the plurality of light emitting sections arranged in each of the plurality of divided areas as a control unit, controls luminance of light emitted by the plurality of light emitting sections, on a per control unit basis, according to the image signal, and wherein part of the plurality of light emitting sections is configured based on a relationship where, between at least two light emitting sections controlled by a first control unit, at least one light emitting section controlled by a second control unit that is different from the first control unit, is provided.

### Advantageous Effects

According to the present device, the backlight device that divides the light source into a plurality of areas and controls luminance of the light source on a per area basis, does not produce significant differences in luminance and can prevent deterioration of image quality, even when an object which, ideally, needs to be displayed with uniform luminance, moves across divided areas of the light source.

That is, according to the present device, the backlight device provides the light source (i.e. light emitting sections) in a predetermined arrangement and provides control units of a predetermined configuration to evenly distribute light from the light source in order to provide a blurring effect matching the resolution of the light source, so that luminance of the light source changes moderately in the boundary portions between adjoining divided areas. Accordingly, the backlight device does not produce significant differences in luminance and improves the way an image looks unnatural, even when an object which, ideally, needs to be displayed with uniform luminance, moves across divided areas of the light source.

### BRIEF DESCRIPTION OF THE DRAWINGS

FIG. 1 is a view showing a schematic configuration of a conventional LED backlight device;

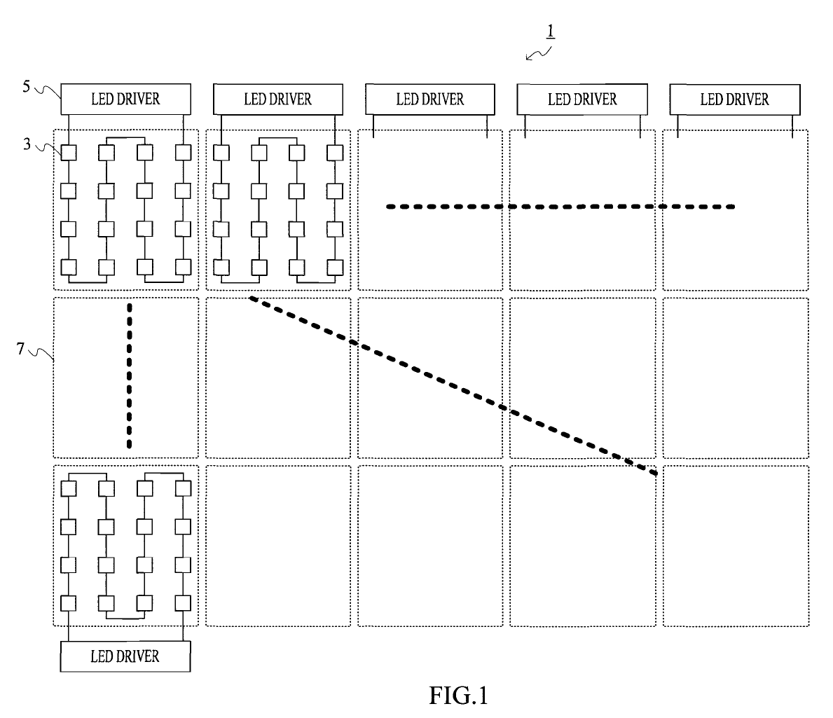

FIGS. 2A-2C illustrate how an image looks when the conventional backlight apparatus performs an area control of a light source, where FIG. 2A shows how a display image moves, FIG. 2B shows how an area illuminated by a backlight moves, and FIG. 2C shows how an actual image looks when the display image and the area illuminated by the backlight overlap;

FIG. 3 is a block diagram showing a schematic configuration of an image display apparatus using the backlight device according to Embodiment 1 of the present invention;

FIG. 4 is a schematic view showing the structure of the main part of an LED backlight device as the backlight device according to the present embodiment;

FIGS. 5A and 5B illustrate characteristics of an LED arrangement pattern shown in FIG. 4, where FIG. 5A is a view magnifying the vicinity of area A, and FIG. 5B is view showing a conventional arrangement pattern as a comparison example;

FIGS. 6A and 6B show an example of the distribution of luminance according to the LED arrangement pattern shown in FIG. 5, where FIG. 6A shows an example of the distribution of luminance according to the LED arrangement pattern of the present embodiment shown in FIG. 6A, and FIG. 6B shows an example of the distribution of luminance according to a conventional LED arrangement pattern shown in FIG. 5B;

FIGS. 7A-7C illustrate how an image looks according to the LED arrangement pattern of the present embodiment shown in FIG. 4, where FIG. 7A shows how a display image moves, FIG. 7B shows how the area illuminated by the backlight moves, and FIG. 7C shows how an actual image looks when the display image and the area illuminated by the backlight overlap;

FIG. 8 is an example of a view magnifying the main part of an LED arrangement pattern of each area of the backlight device according to Embodiment 2 of the present invention; and

FIG. 9 is an example of a view magnifying the main part of an LED arrangement pattern of each area of the backlight device according to Embodiment 3 of the present invention.

### DESCRIPTION OF EMBODIMENTS

Embodiments of the present invention will be explained in detail below with reference to the accompanying drawings.

### Embodiment 1

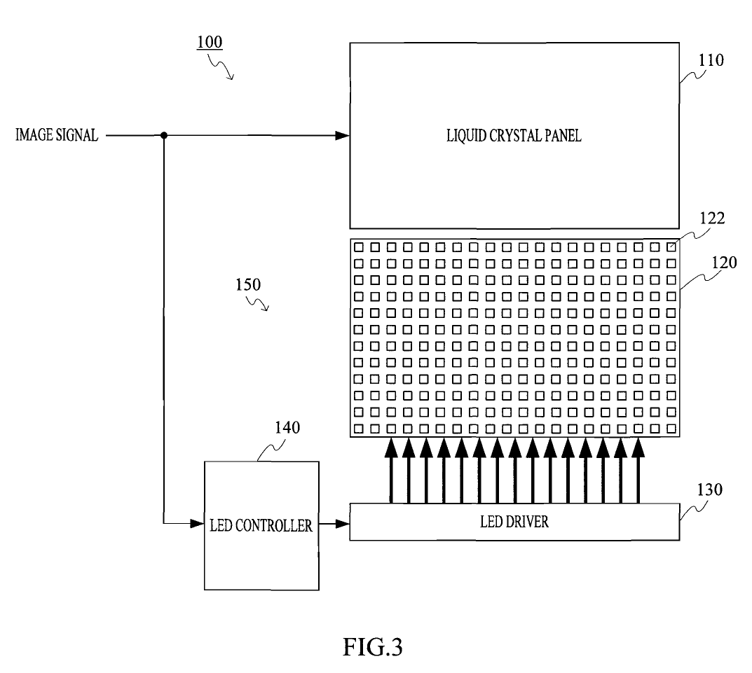

FIG. 3 is a block diagram showing a schematic configuration of an image display apparatus using a backlight device according to Embodiment 1 of the present invention.

Image display apparatus 100 shown in FIG. 3 is a liquid crystal display apparatus, and provides an image display apparatus that expands the dynamic range of the display image by controlling luminance of the backlight light source that illuminates the back of LED backlight panel 120 according to image signals. This image display apparatus 100 generally has liquid crystal panel 110, LED backlight panel 120, LED drivers 130 and LED controller 140. Further, LED backlight panel 120, LED drivers 130 and LED controller 140 constitute LED backlight 150.

Liquid crystal panel 110 optically modulates the illuminating light according to image signals and forms images matching image signals on the display surface. Liquid crystal panel 110 is, for example, a known liquid crystal panel, and is constituted by a polarizing plate, liquid crystal cells and color filters although not shown. Further, liquid crystal panel 110 constitutes an optical modulating section.

LED backlight panel 120 is arranged facing the back of liquid crystal panel 110 and illuminates the back of liquid crystal panel 110 with illuminating light. LED backlight panel 120 is one component of LED backlight 150 in which the light source is divided into a plurality of areas, and is constituted by providing a plurality of LEDs 122 in a predetermined arrangement. The LED 122 group (formed with a predetermined number of LEDs 122) provided in a predetermined arrangement forms one control unit (i.e. area). The control units correspond to a plurality of sub-light sources obtained by dividing the light source. Further, the method of arranging LEDs 122 is one characteristic of the present invention and will be described in detail later. Furthermore, LED 122 constitutes a light emitting section.

LED driver 130 is one component of LED backlight 150 and controls LED backlight panel 120 to drive. To be more specific, although not shown, a number of LED drivers 130 equaling the number of areas of the light source are arranged, and are configured to control luminance of each area separately. That is, each LED driver 130 is connected with an LED 122 group of a corresponding area of LED backlight panel 120, and controls luminance of the light source on a per control unit (i.e. area) basis.

LED controller 140 is one component of LED backlight 150 and calculates luminance of the light source on a per area basis based on an image signal, and outputs data for adjusting light (i.e. target luminance) to LED driver 130 on a per area basis.

In image display apparatus 100 with the above configuration, liquid crystal panel 110 is illuminated by LED backlight 150 (LED backlight panel 120 in particular), the transmittance of liquid crystal panel 110 is spatially modulated by the liquid crystal panel driving device (not shown), and liquid crystal panel 110 displays an image. Further, LED controller 140 controls luminance of the light source on a per area basis, through LED drivers 130, according to image signals. By this means, image display apparatus 100 receives in liquid crystal panel 110 as input light emitted from LED backlight panel 120 to display an image utilizing the phenomenon of transmission and blocking of light in liquid crystal panel 110.

Next, the method of arranging LEDs 122 will be explained.

According to the present invention, to allow an area control for the backlight (for changing the brightness (i.e. luminance) of the backlight on a per area basis according to an image), part of the backlight device is configured based on a relationship where, between at least two light emitting sections (i.e. LEDs 122) controlled by a first control unit, at least one light emitting section (i.e. LED 122) controlled by a second control unit that is different from the first control unit, is provided. Preferably, the first control unit and second control unit are adjoined. With this configuration, it is possible to evenly distribute light on a per area basis and provide a blurring effect matching the resolution of the light source, so that, even when the resolution of the light source is low compared to the display image, a light source control can be performed such that the display image does not look unnatural.

To be more specific, with the present embodiment in particular, a plurality of light emitting sections (i.e. LEDs 122) are arranged evenly in a square grid, and each control unit is formed with sixteen (16) light emitting sections (i.e. LEDs 122) arranged in a square grid of four (4) columns and four (4) rows vertices of which are light emitting sections provided at four (4) corners of light emitting sections of six (6) columns and six (6) rows. Between light emitting sections (LEDs 122) of four (4) columns and four (4) rows that constitute the first control unit, light emitting sections (LEDs 122) of another control unit that is different from the first control unit and that is provided in at least one of eight (8) directions of horizontal, vertical and oblique directions adjoining the first control unit, are provided.

Hereinafter, a specific example of an arrangement pattern of LEDs 122 (hereinafter, also referred to as “LED arrangement pattern”) according to the present embodiment will be explained. Further, it naturally follows that the following specific example is only one example of the present embodiment and the present invention is not limited to this.

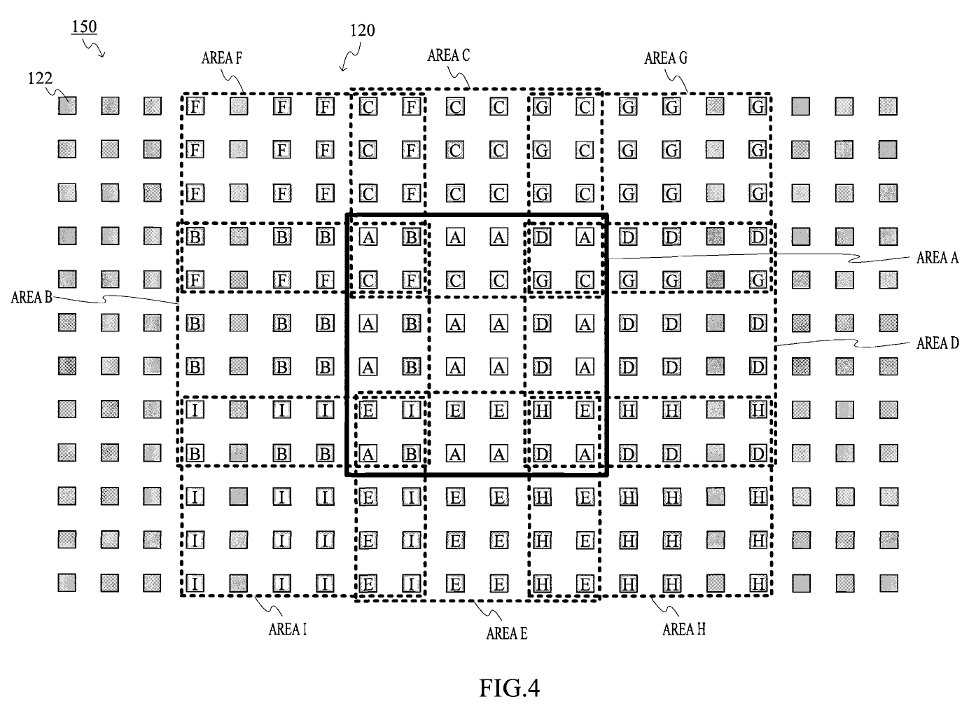

FIG. 4 shows a schematic view showing the structure of a main part of LED backlight 150 as the backlight device according to the present embodiment, and shows a specific example of LED 122 arrangement in LED backlight panel 120. To be more specific, FIG. 4 shows an example of an LED 122 arrangement pattern of each area in backlight panel 120.

FIG. 4 shows an example where the light source is divided into fifteen (15) areas of five (5) columns and three (3) rows. In one area, there are sixteen (16) LEDs 122 of four (4) columns and four (4) rows controlled by a single control unit. In the same figure, “A,” “B,” “C,” “D,” “E,” “F,” “G,” “H,” and “I” assigned to LEDs 122 indicate the area symbols. An LED 122 group of the same symbol is connected to same LED driver 130 (not shown in FIG. 4) to form one control unit. Here, to avoid complication of explanation, the area symbols are assigned to only nine (9) areas of A to I, out of fifteen (15) divided areas of the light source for ease of explanation.

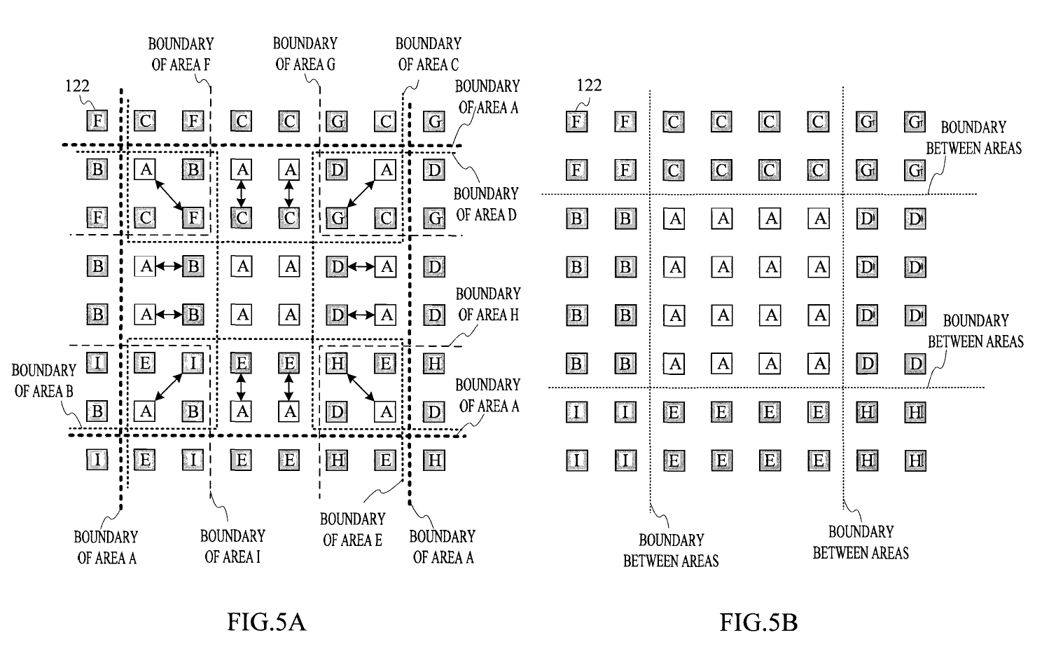

FIG. 5 illustrates characteristics of the LED arrangement pattern shown in FIG. 4, and, particularly, FIG. 5A magnifies the vicinity of area A. FIG. 5B shows a conventional arrangement pattern as a comparison example to clarify the difference from the present invention.

With the examples shown in FIG. 4 and FIG. 5A, 15 (the number of areas)×16 (the number of LEDs in one area)=240 LEDs 122 are arranged evenly in square grid units of six (6) columns and six (6) rows while part of these square grids overlap with each other. Further, each control unit is formed with sixteen (16) LEDs 122 arranged in a square grid of four (4) columns and four (4) rows vertices of which are LEDs 122 provided at four (4) corners of LEDs 122 of six (6) columns and six (6) rows. With the present embodiment, as shown in FIG. 5A, for example, LEDs 122 of area A are arranged such that, in area A of sixteen (16) LEDs 122 of four (4) columns and four (4) rows, outer twelve (12) LEDs 122 are switched with LEDs 122 from eight (8) adjoining areas B, C, D, E, F, G, H and I (see, in particular, the bidirectional arrows in the figure). The eight (8) adjoining areas B, C, D, E, F, G, H and I are areas adjoining area A in the eight (8) directions of horizontal, vertical and oblique directions. In this way, as is clear from comparison with the conventional LED arrangement pattern shown in FIG. 5B, the range of area A is expanded in the LED arrangement pattern of the present embodiment shown in FIG. 5A.

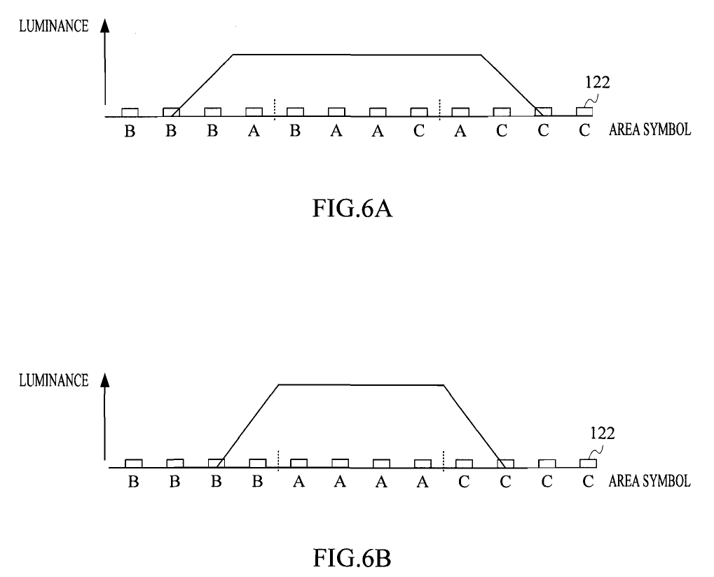

FIG. 6 shows an example of the distribution of luminance according to the LED arrangement patterns shown in FIG. 5, and, to be more specific, shows an example of the distribution of luminance when light is emitted only from the light source (i.e. LEDs 122) of area A in the LED arrangement patterns shown in FIG. 5A and FIG. 5B. Particularly, FIG. 6A shows an example of the distribution of luminance according to the LED arrangement pattern of the present embodiment shown in FIG. 5A, and FIG. 6B shows an example of the distribution of luminance according to a conventional LED arrangement pattern shown in FIG. 5B.

In comparison with FIG. 6B, FIG. 6A shows that the LED arrangement pattern of the present embodiment expands the distribution of luminance in area A. Consequently, according to the LED arrangement pattern of the present embodiment, the light source (i.e. LEDs 122) in one area illuminates an expanded, wider area. By this means, it is possible to blur the boundary portions between adjoining areas, that is, change luminance moderately in the boundary portions between adjoining divided areas of the light source.

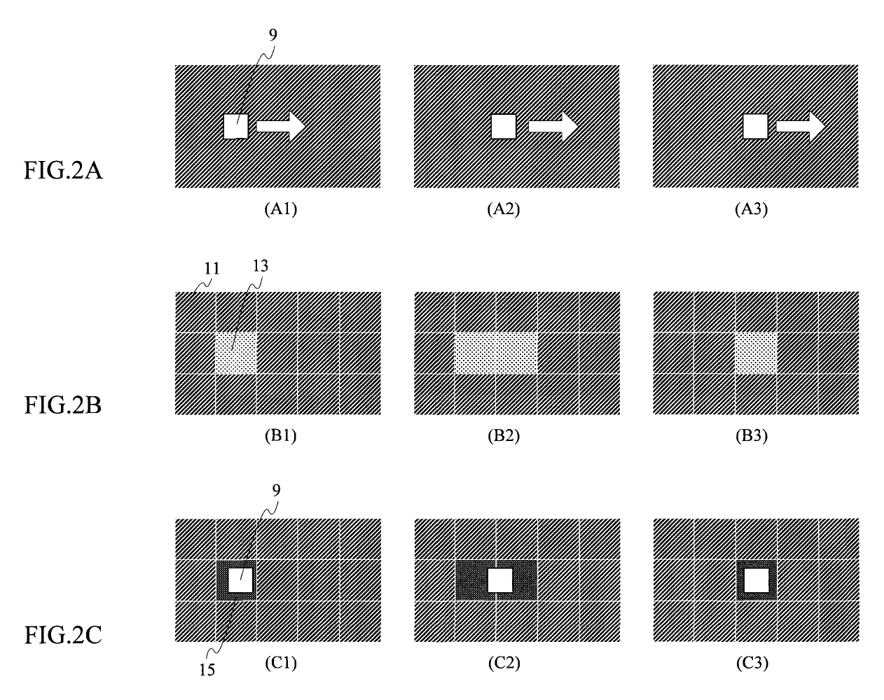

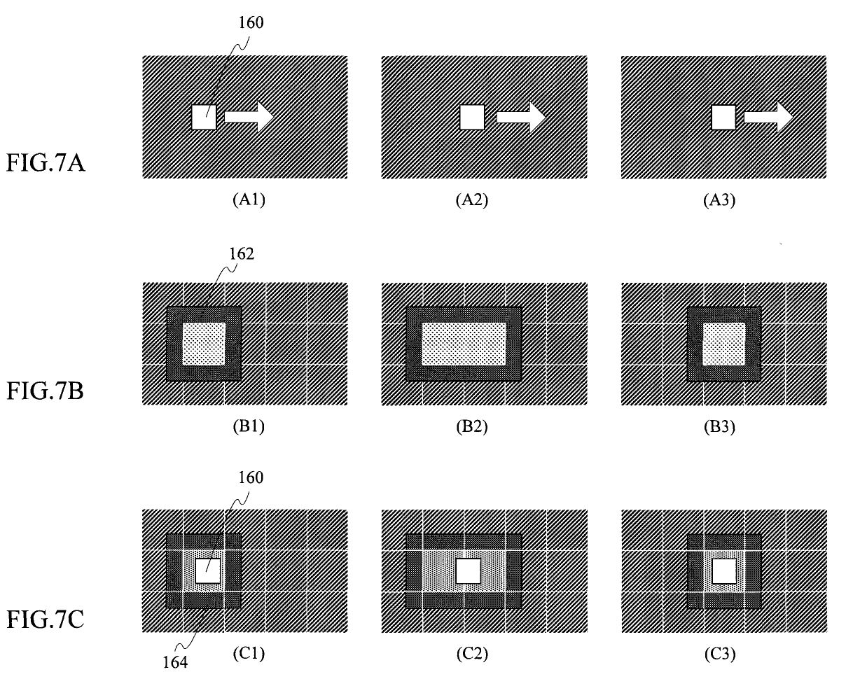

FIG. 7 corresponds to FIG. 2 and illustrates how an image looks with the LED arrangement pattern of the present embodiment shown in FIG. 4. Here, FIG. 7A shows how the display image moves, FIG. 7B shows how the area illuminated by the backlight moves and FIG. 7C shows how an actual image looks when the display image and the area illuminated by the backlight overlap. That is, FIG. 7 shows how an image looks when the display image shown in FIG. 2A is applied to LED backlight 150 of the present embodiment shown in FIG. 3 and FIG. 4.

To be more specific, (A1) to (A3) in FIG. 7A show display images displayed on liquid crystal panel 110 and show that object 160 moves sequentially from (A1) to (A2) and then (A2) to (A3), in order over time. The arrows in (A1) to (A3) show the directions in which object 160 moves. Further, (B1) to (B3) in FIG. 7B correspond to (A1) to (A3) in FIG. 7A, respectively, and show the lighting operation of the backlight in each period of (A1) to (A3). With the present embodiment, as shown in an example of FIG. 7, the light source in the backlight is divided into areas (i.e. control units) of five (5) columns and three (3) rows, and is configured to separately control luminance on a per area basis. Here, as shown in FIG. 6B, the light source (i.e. LEDs 122) of one area illuminates an expanded, wide range compared to a range that is conventionally illuminated.

Similar to a conventional area control, as shown in FIG. 7A and FIG. 7B, LED backlight 150 controls luminance of the light source according to the motion of white object 160 in order to follow an image. That is, area 162 illuminated by the backlight is moved sequentially from (B1) to (B2) and (B2) to (B3), in order, according to the motion of object 160. At this point, with the present embodiment, the LED arrangement pattern shown in FIG. 4 and FIG. 5A expands area 162 illuminated by the backlight compared to the area that is conventionally illuminated (see FIG. 6A), so that luminance changes moderately in the boundary portions between adjoining divided areas of the light source. Consequently, even if the resolution of the light source is low compared to a display image, the size of area 164 emitting bright light does not change (see, in particular, (C2)) when object 160 crosses the boundary of the light source, so that it is possible to display images that are not unnatural.

In this way, the present embodiment elaborates the arrangement pattern of LEDs 122 constituting control units and evenly distribute light from the light source in order to provide a blurring effect matching the resolution of the light source, so that it is possible to change luminance moderately in the boundary portions between adjoining divided areas of the light source. Consequently, the backlight device does not produce significant differences in luminance, and can prevent deterioration of image quality even when an object which, ideally, needs to be displayed with uniform luminance, moves across divided areas of the light source.

Further, although a case has been described with the present embodiment as an example where the light source is divided into fifteen (15) areas of five (5) columns and three (3) rows and where sixteen (16) LEDs 122 of four (4) columns and four (4) rows are arranged in each area, the number of divisions of the light source and the number of LEDs in each area are not limited to these.

Further, although the present embodiment has been explained above referring to an arrangement as an example where, in a given area of sixteen (16) LEDs 122 of four (4) columns and four (4) rows, outer twelve (12) LEDs 122 are switched with LEDs 122 from the eight (8) directions of horizontal, vertical and oblique directions that adjoin this given area, obviously, not all areas adjoin other areas in all eight (8) directions. In this case, LEDs 122 of this given area need to be switched only with LEDs 122 of adjoining areas only in directions where there are adjoining areas. Further, in case where deterioration of performance is allowable to some degree, in some or all of areas, LEDs 122 need not to be switched with LEDs in all directions where there are adjoining areas.

### Embodiment 2

Embodiment 2 is an example of an LED arrangement pattern different from the LED arrangement pattern of Embodiment 1 and pertains to a case where LEDs in each area are arranged at equal intervals.

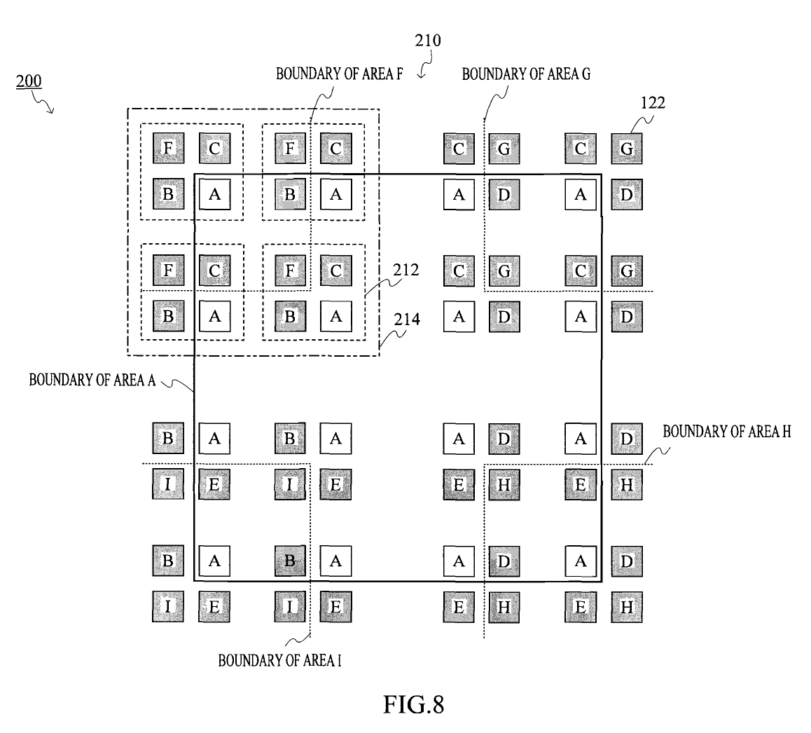

FIG. 8 corresponds to FIG. 5A and is an example of a view magnifying a main part of an LED arrangement pattern of each area in the LED backlight that is the backlight device according to Embodiment 2 of the present invention. Further, this LED backlight 200 has the same basic configuration as corresponding LED backlight 150 of Embodiment 1 shown in FIG. 3, FIG. 4 and FIG. 5A except for the LED arrangement pattern in LED backlight panel 210, and the same components will be assigned the same reference numerals and explanation thereof will be omitted. Further, an image display apparatus using this LED backlight 200 has the same basic configuration as corresponding image display apparatus 100 of Embodiment 1 shown in FIG. 3 except for the portion of the backlight device, and, therefore, explanation thereof will be omitted.

With the present embodiment, to arrange LEDs 122 at equal intervals in each area, a plurality of light emitting sections (i.e. LEDs 122) make a first set that is formed with four (4) light emitting sections (i.e. LEDs 122) arranged in a square grid of two (2) columns and two (2) rows, and four (4) of the first sets, which are arranged in a square grid, constitute a second set. Further, one light emitting section (i.e. LED 122) from each of the four (4) first sets included in each of four (4) adjoining second sets is assigned to the light emitting sections (i.e. LEDs 122) of each control unit, and is arranged in a square grid of four (4) columns and four (4) rows.

FIG. 8 shows an example of the LED arrangement pattern according to the present embodiment and is a view magnifying the vicinity of area A. Here, the number of LEDs 122 in each area is sixteen (16). As shown in FIG. 8, the present embodiment has characteristics where sixteen (16) LEDs 122 in each area are arranged at equal intervals in LED backlight panel 210.

To be more specific, as to how LEDs 122 are arranged in LED backlight panel 210, this LED backlight 200 has sets 212 each formed with four (4) LEDs 122 arranged in a square grid of two (2) columns and two (2) rows, and constitutes one set 214 by arranging the four (4) sets of these sets 212 each formed with four (4) LEDs 122, in a square grid. Then, one light emitting section from each of light emitting sections of two (2) columns and two (2) rows (i.e. four (4) sets 212) included in each of four (4) adjoining sets 214 (for example, LEDs in area A) is assigned to LEDs 122 of each control unit, and is arranged in a square grid of four (4) columns and four (4) rows. At this time, sixteen (16) LEDs 122 in each area are arranged at equal intervals.

According to this configuration, LEDs 122 in each area are arranged at equal intervals in LED backlight panel 210, and, consequently, there is little variation in the distribution of luminance in LEDs 122 in one area decrease, so that, even when LEDs 122 have light distribution characteristics where LEDs 122 emit light at a low illumination angle, light can be distributed evenly in each area. Further, thanks to this configuration, like Embodiment 1, the light source (i.e. LEDs 122) in one area illuminates an expanded, wide range compared to a range that is conventionally illuminated.

In this way, the present embodiment elaborates the arrangement pattern of LEDs 122 constituting control units and evenly distribute light from the light source in order to provide a blurring effect matching the resolution of the light source, so that it is possible to change luminance moderately in the boundary portions between adjoining divided areas of the light source. Consequently, the backlight device does not produce significant differences in luminance, and can prevent deterioration of image quality even when an object, which, ideally, needs to be displayed with uniform luminance, moves across divided areas of the light source.

Further, according to the present embodiment, LEDs 122 in each area are arranged at equal intervals in LED backlight panel 210. Consequently, in case where only a single area emits light, even when LEDs 122 emits light at a low illumination angle, light can be distributed evenly in this area.

Further, although a case has been explained with the present embodiment as an example where the light source is divided into fifteen (15) areas of five (5) columns and three (3) rows and where sixteen (16) LEDs 122 of four (4) columns and four (4) rows are arranged in each area, the number of divisions of the light source and the number of LEDs are not limited to these.

### Embodiment 3

Embodiment 3 has characteristics of both the LED arrangement pattern according to Embodiment 1 and the arrangement pattern according to Embodiment 2. That is, with Embodiment 1, although all LEDs are evenly arranged, LEDs are not evenly arranged in a single area. By contrast with this, with Embodiment 2, although all LEDs are not evenly arranged, LEDs are evenly arranged in a single area. Embodiment 3 has characteristics that the overall arrangement of LEDs and the arrangement of LEDs in a single area are uniform.

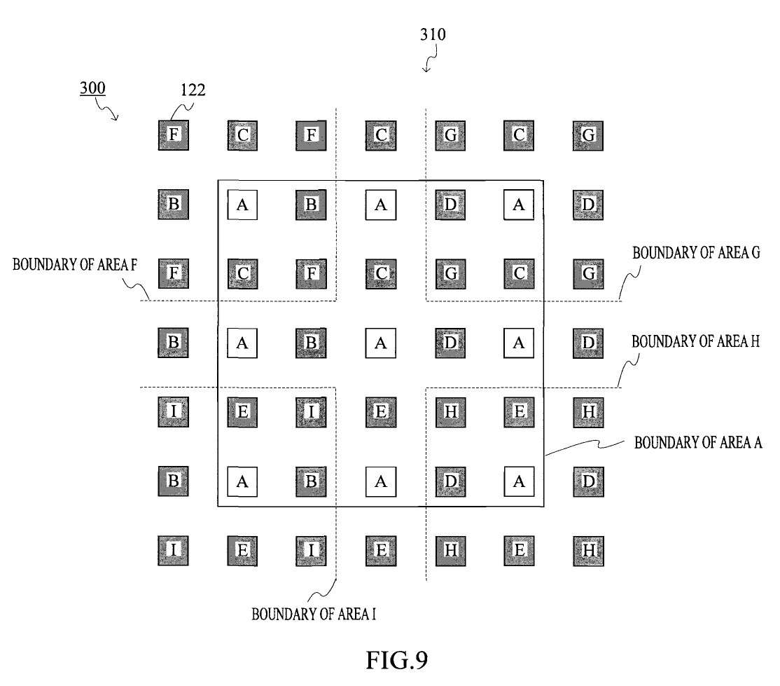

FIG. 9 corresponds to FIG. 5A and FIG. 8, and is an example of a view magnifying a main part of an LED arrangement pattern of each area in the LED backlight as the backlight device according to Embodiment 3 of the present invention. Further, this LED backlight 300 has the same basic configuration as corresponding LED backlight 150 of Embodiment 1 shown in FIG. 3, FIG. 4 and FIG. 5A except for the LED arrangement of LED backlight panel 310, and the same components will be assigned the same reference numerals and explanation thereof will be omitted. Further, an image display apparatus using this LED backlight 300 has the same basic configuration as corresponding image display apparatus 100 of Embodiment 1 shown in FIG. 3 except for the backlight device and, therefore, explanation thereof will be omitted.

With the present embodiment, to combine the characteristics of both the LED arrangement pattern of Embodiment 1 and the arrangement pattern of Embodiment 2, a plurality of light emitting sections (i.e. LEDs 22) are evenly arranged in a square grid, and each control unit is formed with nine (9) light emitting sections (i.e. LEDs 122) arranged in a square grid of three (3) columns and three (3) rows vertices of which are the light emitting sections provided at four (4) corners of light emitting sections (i.e. LEDs 122) of five (5) columns and five (5) rows. Further, between light emitting sections (LEDs 122) of three (3) columns and three (3) rows that constitute the first control unit, light emitting sections (LEDs 122) of another control unit that is different from the first control unit and that is provided in at least one of the eight (8) directions of horizontal, vertical and oblique directions adjoining the first control unit, are provided. In this case, the number of LEDs in each area is nine (9) to provide the characteristic of the arrangement pattern of Embodiment 2 (that is, among LEDs 122 in each area at equal intervals).

To be more specific, in this LED backlight 300, a predetermined number of LEDs 122 are arranged evenly in a square grid. That is, with the present embodiment, “in a square grid” means that all LEDs 122 are arranged in a square grid, and also means that nine (9) LEDs 122 of one control unit of three (3) columns and three (3) rows are arranged in a square grid. With Embodiment 1, although all LEDs 122 are arranged in a square grid, sixteen (16) LEDs 122 in one control unit of four (4) columns and four (4) rows are not arranged in a square grid. Further, with the present embodiment, each control unit is formed with nine (9) LEDs 122 of three (3) columns and three (3) rows vertices of which are LEDs 122 provided at four (4) corners of LEDs 122 of five (5) columns and five (5) rows. At this time, as shown in FIG. 9, for example, LEDs 122 of area A are arranged such that, in area A of nine (9) LEDs 122 of three (3) columns and three (3) rows, outer eight (8) LEDs 122 are switched with LEDs 122 from eight (8) adjoining areas B, C, D, E, F, G, H and I. The eight (8) adjoining areas B, C, D, E, F, G, H and I are areas adjoining area A in the eight directions of horizontal, vertical and oblique directions. In this way, with the LED arrangement pattern of the present embodiment shown in FIG. 9, the range of each area is expanded in comparison with the conventional LED arrangement pattern and LEDs 122 in each area are evenly arranged similar to the conventional arrangement pattern.

In this way, the present embodiment elaborates the arrangement pattern of LEDs 122 constituting a control unit and evenly distributes light from the light source in order to provide a blurring effect matching the resolution of the light source, so that it is possible to change luminance moderately in the boundary portions between adjoining divided areas of the light source. Consequently, the backlight device does not produce significant differences in luminance, and can prevent deterioration of image quality even when an object which, ideally, needs to be displayed with uniform luminance, moves across divided areas of the light source.

Further, according to the present embodiment, LEDs 122 in each area are evenly arranged in LED backlight panel 310. Consequently, in case where only a single area emits light, even when LEDs 122 emit light at a low illumination angle, light can be evenly distributed in this area. Further, all LEDs are arranged evenly. Consequently, light can be evenly distributed even when all areas are illuminated.

Further, although the present embodiment has been explained referring to an arrangement as an example where, in a given area of nine (9) LEDs 122 of three (3) columns and three (3) rows, outer eight (8) LEDs 122 are switched with LEDs 122 from all areas that are provided in the eight (8) directions of horizontal, vertical and oblique directions and that are adjoining this area, obviously, not all areas adjoin other areas in all eight (8) directions. In this case, LEDs 122 in this given area need to be switched only with LEDs 122 of adjoining areas only in the directions where there are adjoining this area. Further, in case where deterioration of performance is allowable to some degree, in some of all of areas, LEDs 122 need not to be switched with LEDs in all directions where there are adjoining areas.

Further, the above embodiments elaborate the arrangement patterns of LEDs 122 constituting the control units and expand the range illuminated by the light source (i.e. LED 122's) of one area in order to blur the boundary portions between adjoining areas, that is, in order to blur the light source. The light source can be blurred in this way by, for example, adjusting LED lenses and controlling luminance of each area taking into account luminance of adjoining areas. However, with the method of adjusting LED lenses to widen the illumination angles at which LEDs emit light, the size of lenses needs to be made bigger, which increases cost. Further, a method of controlling luminance taking into account luminance of the surrounding areas so as not to produce significant differences in luminance compared to the surrounding areas only allows control in area units, by which, unlike the present invention, it is not possible to blur only the boundary portions between adjoining areas. Consequently, blurring only the boundary portions between adjoining areas without increasing cost, is unique to the present invention. Accordingly, the present invention provides a substantial effect upon backlight devices in addition to power saving and dynamic range expansion by performing an area control of the light source.

### INDUSTRIAL APPLICABILITY

The backlight device according to the present invention that divides the light source into a plurality of areas and controls luminance of the light source on a per area basis, provides advantages of not producing significant differences in luminance, and preventing deterioration of image quality, even when an object which, ideally, needs to be displayed with uniform luminance, moves across divided areas of the light source, and is useful as, for example, backlights in image display apparatuses that require light sources such as liquid crystal displays.

### REFERENCE SIGNS LIST

100 image display apparatus
110 liquid crystal panel
120, 210, 310 LED backlight panel
122 LED
130 LED driver
140 LED controller
150, 200, 300 LED backlight

1. A backlight device that illuminates an optical modulating section, which displays an image according to an image signal, with illuminating light to allow the optical modulating section to display the image, the backlight device comprising:
a plurality of light emitting sections that emit the illuminating light to illuminate the optical modulating section, at least one of which is arranged with respect to each of a plurality of divided areas to illuminate the illuminating light separately in a plurality of areas; and
a controlling section that, using the at least one of the plurality of light emitting sections arranged in each of the plurality of divided areas as a control unit, controls luminance of light emitted by the plurality of light emitting sections, on a per control unit basis, according to the image signal,
wherein part of the plurality of light emitting sections is configured based on a relationship where, between at least two light emitting sections controlled by a first control unit, at least one light emitting section controlled by a second control unit that is different from the first control unit, is provided.

2. The backlight device according to claim 1, wherein the first control unit and the second control unit are adjoined.

3. The backlight device according to claim 1, wherein:
the plurality of light emitting sections are arranged evenly in a square grid;
each of the control units comprises sixteen light emitting sections arranged in a square grid of four columns and four rows vertices of which are light emitting sections provided at four corners of light emitting sections of six columns and six rows; and
between light emitting sections of four columns and four rows that constitute the first control unit, light emitting sections of another control unit that is different from the first control unit and that is provided in at least one of eight directions of horizontal, vertical and oblique directions adjoining the first control unit, are provided.

4. The backlight device according to claim 1, wherein:
the plurality of light emitting sections make a first set that is comprised of four light emitting sections arranged in a square grid of two columns and two rows;
four of the first sets, which are arranged in a square grid, constitute a second set; and
one light emitting section from each of the four first sets included in each of four adjoining second sets is assigned to the light emitting sections of each of the control units, and is arranged in a square grid of four columns and four rows.

5. The backlight device according to claim 1, wherein:
the plurality of light emitting sections are evenly arranged in a square grid;
each of the control units is comprised of nine light emitting sections arranged in a square grid of three columns and three rows vertices of which are light emitting sections provided at four corners of light emitting sections of five columns and five rows; and
between light emitting sections of three columns and three rows that constitute the first control unit, light emitting sections of another control unit that is different from the first control unit and that is provided in at least one of eight directions of horizontal, vertical and oblique directions adjoining the first control unit, are provided.

6. An image display apparatus comprising:
the backlight device according to claim 1; and
an optical modulating section that is illuminated by the backlight device and that displays an image according to an image signal.

7. An image display apparatus comprising:
the backlight device according to claim 2; and
an optical modulating section that is illuminated by the backlight device and that displays an image according to an image signal.

8. An image display apparatus comprising:
the backlight device according to claim 3; and
an optical modulating section that is illuminated by the backlight device and that displays an image according to an image signal.

9. An image display apparatus comprising:
the backlight device according to claim 4; and
an optical modulating section that is illuminated by the backlight device and that displays an image according to an image signal.

10. An image display apparatus comprising:
the backlight device according to claim 5; and
an optical modulating section that is illuminated by the backlight device and that displays an image according to an image signal.
